(19) United States
(12) Patent Application Publication
(10) Pub. No.: US 2018/0352795 A1
(43) Pub. Date: Dec. 13, 2018

(54) STICKY TRAP FOR INSECTS

(71) Applicant: ZOBELE HOLDING SPA, Trento (IT)

(72) Inventors: Cedric GOBBER, Barcelona (ES); Joaquim LLORENTE ALONSO, Barcelona (ES); Åsa JONSSON, Trento (IT)

(21) Appl. No.: 15/780,065

(22) PCT Filed: Dec. 5, 2016
(86) PCT No.: PCT/EP2016/079722

§ 371 Date: May 30, 2018

(30) Foreign Application Priority Data
Dec. 3, 2015 (ES) P201531757

(51) Int. Cl. A01M 1/14

(52) U.S. Cl. CPC A01M 1/14

(57) ABSTRACT

An insect trap formed from a sheet that defines an adhesive surface, the sheet including on two opposite ends engaging means in order to engage said opposite ends together. The adhesive surface is curved when the opposite ends are engaged together, thus allowing the insect trap to be used in any location, including inside a cupboard or on a table.

The present invention relates to an insect trap that keeps insects adhered to a surface with adhesive characteristics.

### BACKGROUND OF THE INVENTION

The use of traps for insects, such as moths, is common, where these traps are formed by a flat sheet that comprises a surface with adhesive characteristics.

For example, it is common to place a trap of this type in cupboards where food is stored, so that the insects remain adhered to said adhesive surface.

Furthermore, in order to attract insects, it is also common that said surface with adhesive characteristics is impregnated with aromas that make insects rest on the adhesive surface, where they remain trapped.

Although this type of insect trap formed by a sheet that defines a flat adhesive surface is suitable for use in spaces such as the inside of a cupboard, it is not suitable for use in other places, such as on a table in a dining room or restaurant.

Therefore, the objective of the present invention is to provide a more versatile insect trap that can be used in any space desired, such as a restaurant table, a bar top, etc.

### Description of the Invention

The insect trap of the invention resolves the aforementioned drawbacks and has other advantages which are described below.

The insect trap according to the present invention is formed from a sheet that defines an adhesive surface, and is characterized in that said sheet comprises on two opposite ends engaging means for engaging said opposite ends together, defining a curved adhesive surface when said opposite ends are engaged together.

According to a preferred embodiment, said engaging means comprise a complementary tab and slot, for example, of a semicircular shape.

Furthermore, according to two alternate embodiments, said sheet comprises a curved edge or a curved folding line that defines a base of the insect trap when said opposite ends are engaged together.

Said curved folding line also advantageously defines an inner cone when said opposite ends are engaged together, and is preferably die cast in a discontinuous way.

Preferably, said adhesive surface encompasses a part of one side of said sheet, which is covered by a protection sheet before its first use; this facilitates its handling and prevents the loss of its properties before its use.

Thanks to the presence of said engaging means which allow the insect trap to have a curved adhesive surface, the insect trap can be used in any space, including inside a cupboard or on a restaurant table or bar top, for example.

### BRIEF DESCRIPTION OF THE DRAWINGS

For the purpose of helping to make the foregoing description more readily understandable, it is accompanied by a set of drawings that, schematically and by way of illustration and not limitation, represent an embodiment.

FIG. 1 is a plan view of the sheet that forms the insect trap of the present invention, according to a first embodiment;

FIG. 2 is a perspective view of the insect trap of the present invention, according to a first embodiment;

FIG. 3 is a plan view of the sheet that forms the insect trap of the present invention, according to a second embodiment; and

FIG. 4 is a perspective view of the insect trap of the present invention, according to said second embodiment.

### DESCRIPTION OF A PREFERRED EMBODIMENT

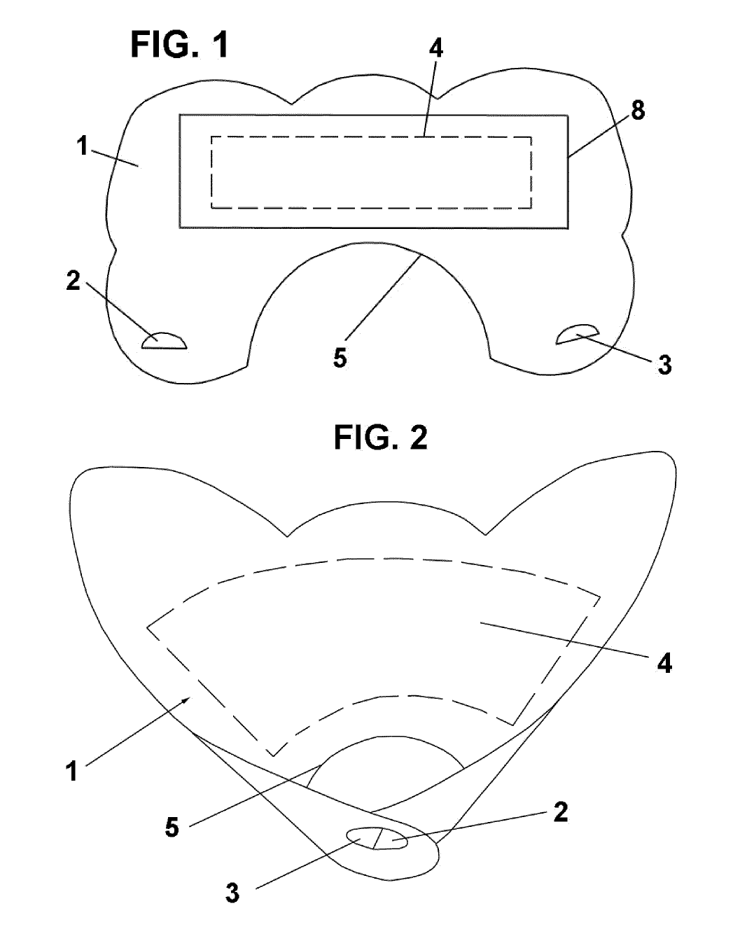

The insect trap according to the present invention is formed from a sheet 1 that is shown in its unfolded position in FIG. 1.

This sheet 1 comprises engaging means on two opposite ends in order to be engaged together, defining a curved surface.

In the embodiment represented in FIG. 1, said engaging means are formed by a complementary tab 2 and a slot 3, for example, of a semicircular shape.

In its mounted position, shown in FIG. 2, the insect trap according to the present invention defines a curved surface 4 that has adhesive characteristics so that the insects remain adhered to it when they rest on it. In order to attract the insects to said adhesive surface 4, the surface can be impregnated with aromas or have bright colors that attract them, where the adhesive surface is brighter or has a greater contrast than the rest of the sheet 1.

Preferably, said adhesive surface 4 only encompasses a part of one side of said sheet 1, which is covered by a protection sheet 8 before its first use.

In the mounted position, the insect trap according to the present invention can be placed on a flat surface, such as a table. To this end, the sheet 1 comprises a curved edge 5 that defines a base for the placement of the insect trap on a flat surface.

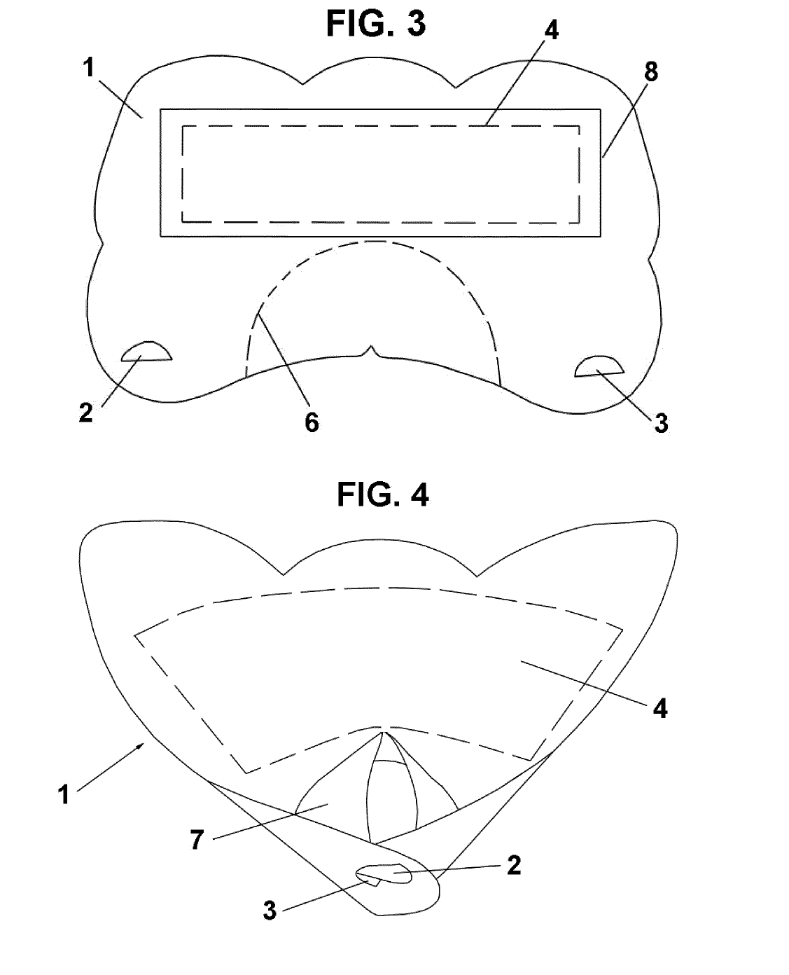

FIG. 3 shows an alternative embodiment of the insect trap according to the present invention, the only difference from the embodiment shown in FIGS. 1 and 2 being that the sheet comprises a curved folding line 6 that defines said base for the placement of the insect trap on a flat surface.

This folding line defines an inner cone 7 in the mounted position of the insect trap according to the present invention, as shown in FIG. 4, which increases the adhesive surface to trap insects.

To facilitate transport thereof, the sheet 1 is provided to the user unfolded, as shown in FIG. 1. In order to use it, the user must simply engage the ends of the sheet 1 together, for example, by introducing the complementary tab 2 into its slot 3. Once it is in its mounted position or position of use, the insect trap according to the present invention can be placed on a flat surface, for example, on a table or even inside a cupboard.

Despite the fact that reference has been made to a specific embodiment of the invention, it is evident for the person skilled in the art that numerous variations and changes may be made to the insect trap described, and that all the aforementioned details may be substituted by other technically equivalent ones, without detracting from the scope of protection defined by the attached claims.

1. An insect trap comprising:
a sheet that includes an adhesive surface configured to trap insects,
wherein said sheet comprises sheet engagers positioned on two opposite ends of said sheet;
the sheet engagers configured to secure and to engage together said opposite ends such that said adhesive surface is curved when said opposite ends are engaged together.

2. The insect trap according to claim 1, wherein said sheet engagers comprise a tab and a complementary slot configured to engage the tab.

3. The insect trap according to claim 2, wherein said tab and said slot have a semicircular shape.

4. The insect trap according to claim 1, wherein said sheet comprises a curved edge that defines a base of the insect trap when said opposite ends are engaged together.

5. The insect trap according to claim 1, wherein said sheet comprises a curved folding line that defines a base for the insect trap when said opposite ends are engaged together.

6. The insect trap according to claim 5, wherein said curved folding line also defines an inner cone when said opposite ends are engaged together.

7. The insect trap according to claim 5, wherein said curved folding line is die cut in a discontinuous way.

8. The insect trap according to claim 1, wherein said adhesive surface encompasses a first part of one side of said sheet, and the insect trap further comprises:
a protection sheet that covers the first part before first use of the insect trap.
